(19) United States
(12) Patent Application Publication
(10) Pub. No.: US 2003/0016937 A1
(43) Pub. Date: Jan. 23, 2003

(54) Variable optic attenuator by waveguide bend loss

(76) Inventors: Stephen J. Caracci, Elmira, NY (US); Sean M. Garner, Elmira, NY (US)

Correspondence Address: George E. Quillin, Foley & Lardner, Washington Harbour, 3000 K Street, N.W., Suite 500, Washington, DC, 20007-5109, US

(21) Appl. No.: 09/792,733

(22) Filed: Feb. 23, 2001

(51) Int. Cl. G02B 6/26

(52) U.S. Cl. 385/140; 385/40; 385/142; 385/144

(57) ABSTRACT

A variable optic attenuator (VOA) comprises a waveguide where the core and cladding layers are comprised of the same class of material. This waveguide also has a curved region, where an electrode is disposed, such that when the electrode receives a signal, the vertical optical confinement of the curved region of the waveguide is altered. A method of variable optical attenuation includes providing a waveguide wherein the core and cladding regions are comprised of the same class of material. This waveguide also includes a curved region, where an electrode is disposed. The vertical confinement of an optical mode of an optical signal is altered by sending a signal to the electrode.

### BACKGROUND OF THE INVENTION

1. Field of the Invention

This invention generally relates to the field of guided wave optics, and in particular to a variable optical attenuator that can control the radiation loss of a waveguide bend by altering the vertical confinement of an optical signal.

2. Description of the Related Art

In optical networks, a conventional variable optical attenuator (VOA) is multiple optical channels, and to reduce cross-talk between switches. Conventional VOAs consist of either mechanical or integrated optic devices. Mechanical devices generally operate by changing either the fiber-to-fiber coupling efficiency or the fiber bending loss. Integrated optic devices—which include Y-branch switches, directional couplers, and Mach-Zehnder modulators—operate on modal interference or adiabatic principles. The performance of these integrated devices is not scaleable with length, and their attenuation is generally about 25 dB—which is insufficient to reduce cross-talk effects.

An example VOA is described in Veldhuis, et al., “Integrated optic intensity modulator based on a bent channel waveguide,” Optics Communications 168, pp. 481-491 (September 1999). The VOA described therein operates by forcing the optical mode to shift horizontally. The optical mode is shifted horizontally by creating a lateral change in the index of refraction between the core and cladding. This shift requires different material systems for the core and cladding, as well as considerably larger driving power. These requirements add additional steps to the fabrication procedure, introduce material compatibility issues, and increase device response times. Furthermore, this conventional design is highly sensitive to environmental conditions (such as ambient temperature and relative humidity) and may introduce polarization dependence due to stress birefringence.

Thus, there remains a need for a low-cost, high-performance VOA that is capable of attenuating an optical signal in excess of 30 dB.

### SUMMARY OF THE INVENTION

In view of the foregoing, according to one embodiment of the present invention, a VOA comprises a waveguide wherein the core and cladding layers are comprised of the same class of material. This waveguide also has a curved region, where an electrode is disposed, such that when the electrode receives a signal, the vertical optical confinement of the curved region of the waveguide is altered.

According to a second embodiment of the present invention, a method of variable optical attenuation is disclosed. This method includes the steps of providing a waveguide wherein the core and cladding regions are comprised of the same class of material. This waveguide also includes a curved region, where an electrode is disposed. The vertical confinement of an optical mode of an optical signal is altered by sending a signal to the electrode.

Other objects, advantages and novel features of the present invention will become apparent from the following detailed description of the invention when considered in conjunction with the accompanying drawings.

### BRIEF DESCRIPTION OF THE DRAWINGS

FIG. 1 is a plan view schematically showing a VOA in accordance with one embodiment of the present invention.

FIG. 2 is a fragmentary, cross-sectional view of the VOA taken along I-I line in FIG. 1.

FIG. 3 is a plot of the VOA response when the temperature of the heater has increased by a given amount.

FIG. 4 is a first beam propagation plot for one representative embodiment of the present invention with a first heater temperature.

FIG. 5 is a second beam propagation plot for one representative embodiment of the present invention with a second heater temperature.

FIG. 6 is a plot illustrating that the attenuation is linearly dependent on the length of the bend region.

FIG. 7 is a plan view schematically showing incorporation of the VOA according to an embodiment of the present invention into a Y-branch switch.

FIG. 8 is a plan view schematically showing incorporation of a feedback control circuit into the VOA according to another embodiment of the present invention.

FIG. 9 is a chart showing the wavelength dependence of the present invention.

FIG. 10 is a diagram of one embodiment of the present invention, with accompanying cross-sectional diagrams showing the location of the optical energy at different points along the waveguide.

FIG. 11 is a schematic diagram showing incorporation of a wavelength response compensator into the present invention.

FIG. 12 is a schematic diagram showing a technique for fabricating a VOA according to a preferred embodiment of the present invention.

FIG. 13 shows a tapered waveguide in the curved region according to another embodiment of the present invention

FIG. 14 is a plot of the attenuation achieved using the embodiment of the present invention illustrated in FIG. 13.

FIG. 15 is a schematic diagram showing a VOA disposed at the ends of an optical cross connect for power equalization according to another embodiment of the present invention.

FIG. 16 is a chemical structure of a preferred low loss waveguide polymer material.

### DETAILED DESCRIPTION OF THE PREFERRED EMBODIMENTS

The present invention is related to a variable optical attenuator (VOA) and a method of variable optic attenuation. The inventors have discovered, contrary to conventional understanding, that a VOA can be designed that alters the vertical optical mode confinement of an optical signal therein, as opposed to a VOA that operates with only the horizontal optical mode confinement being altered. As will be described in detail below, VOAs constructed according to the embodiments of the present invention can reduce cross-talk, response times, power requirements, and potentially reduce manufacturing costs, while increasing the maximum possible attenuation.

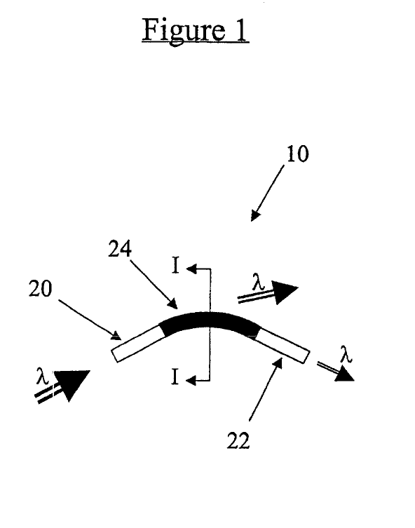

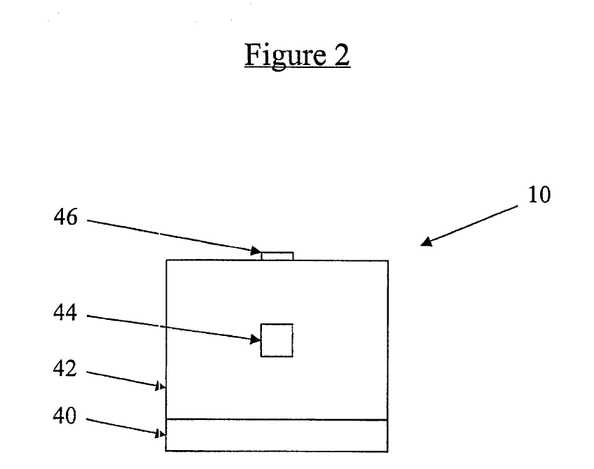

Referring now to FIGS. 1 and 2, there is shown a VOA according to one embodiment of the present invention. VOA 10 includes a waveguide input section 20, a curved attenuation region 24, and a waveguide output section 22. VOA 10 can be mounted on a substrate 40, which can also act as a heat sink. The input and output sections 20 and 22 are preferably straight and provide fiber coupling and mode stabilization. The attenuation region 24 includes an arc-shaped waveguide having a bend radius. The arc shade may be circular or another function such as eplliptical and parabolic arcs. In addition, the bend radius of the arc-shaped section need not be constant, as parabolic and elliptical arcs have non-constant radii. The attenuation region 24 also includes an electrode 46, which can comprise metallic heaters, electro-optic devices having a pair of individual electrodes (one placed above the core and one placed below), and devices having electrodes that are horizontally offset In a preferred embodiment, electrode 46 is a conventional metallic heater, positioned vertically above the core 44. The core 44 is surrounded by the cladding 42. In addition, an optical fiber can also be utilized, instead of or in conjunction with a planar waveguide structure, so long as a thermal gradient is created in the bending region.

According to one embodiment of the present invention, the core and cladding regions are comprised of similar class of material. In addition, the core and cladding materials have similar thermo-optic responses. For example, in one preferred embodiment, both regions may be composed of a polymeric material. In another preferred embodiment, the core and cladding regions may both be composed of a glass. For example, the core 44 and the cladding 42 can both be comprised of a fluorinated acrylate. In this case, the core 44 can have a refractive index in the range of 1.31-1.35 at a wavelength of 1.55 micrometers (μm), and the cladding 42 can have a refractive index 0.3%-1% less than the core.

In this configuration, applying power to heater 46 creates a vertical temperature gradient in the waveguide. Since an increase in temperature decreases the refractive index of polymer films, the cladding near the heater 46 has the greatest reduction of index, and the cladding near the substrate 40 has the smallest index change. This vertical index gradient pushes the optical mode away from the reduced upper cladding index and towards the lower cladding. Thus, a mode profile of an optical signal propagating through the curved region of the VOA is altered to a vertical asymmetric mode profile that radiates power in the curved region. As discussed below, an alternative VOA design is also possible that initially has a vertically asymmetric mode.

The optical mode shift is illustrated in FIG. 10, which shows the location of the optical energy of an optical signal in the waveguide at four different VOA positions given an applied power to the electrode. For example, in the input and output straight portions of the waveguide 120 and 122, the optical mode is located in the center of the waveguide, as shown in cross-sectional views 126 and 128. In the curved region of the waveguide 124, where thermal energy is applied to the waveguide via the electrode, the optical mode is vertically displaced away from the electrode (downwards) and toward the outside of the curved region (to the right), as shown in cross-sectional views 130 and 132. The horizontal displacement is an inherent effect of a waveguide bend. The vertical mode shift causes a vertical asymmetric mode profile in the waveguide, causing optical energy to be radiated from the waveguide bend 134.

This process of shifting the location of the optical mode allows control of the radiation loss that occurs while an optical signal propagates through the curved waveguide region. Variable attenuation is achieved by controlling the vertical distortion of the mode, which can be controlled by applying a control signal to the electrode located on top of the curved region to reduce the optical confinement of the waveguide core. The VOA according to a preferred embodiment uses the thermo-optic effect in polymers. Alternatively, a VOA based on other methods of changing the mode confinement in waveguides, such as the electro-optic effect, are also contemplated, as would be apparent to one of ordinary skill in the art given the present description.

According to another embodiment of the present invention, a VOA design is also possible that initially has a vertically asymmetric mode. In this case, power to heater 46 is used to reduce attenuation. In this alternative VOA design, an optical signal initially has a vertically asymmetric mode and is incident on the input waveguide section. As an electrical signal is applied to the heater (and heat is applied to the waveguide), the asymmetry and optical loss decrease. This alternative design has the opposite functionality to the embodiment described above, in that if no heat is applied to the waveguide, a high signal loss results, and if heat is applied to the waveguide, no signal loss is achieved.

The waveguide bend design increases the attainable extinction ratio in several ways. First, a major cause of attenuation is bending radiation and not mode extinction as is the case for a straight waveguide design. Notably, complete extinction of the waveguide is not required to produce variable attenuation. The presence of bending radiation loss reduces the amount of power that would be required to achieve the same power reduction in a straight waveguide.

Second, the waveguide bend ensures the straight waveguide output is located outside of the diffracting path of the radiating field. For a straight waveguide, the output waveguide collects some of the diffracting power of the unguided mode. For the curved waveguide, however, not only has the output waveguide been moved several millimeters away from the diffracting power, but its acceptance angle is also tilted. These factors can increase the performance of the curved waveguide design as shown in FIGS. 1 and 2. The maximum attenuation possible for this device can be limited by the diffraction and scattering of the radiating field into the output waveguide. By placing the output waveguide away from the input section, the light incident into the output can be minimized.

FIG. 3 shows an example simulation for a 7 μm wide waveguide with a core-cladding index difference of 0.5%. The attenuation region has a bending radius of about 7.6 millimeters (mm) and a total path length of about 5 mm. The graph shows the power attenuation as a function of the electrode temperature increase above the ambient located over the curved region. For this example, the wavelength was 1.55 μm, and the polymer thermo-optic coefficient (dn/dT) was −2.5×10⁻⁴ K⁻¹.

In a preferred embodiment, the optical signal power attenuation can be controlled by varying the power applied to the heater. For example, FIG. 3 (graph portion 144) shows that a very large region exists where the output power is dependent on the heater temperature. Also, the optical power becomes unguided well below the temperature change necessary to completely eliminate the core-cladding index difference. This can occur due to the fact that a bending waveguide requires a larger index difference to guide light than a straight waveguide. The curved waveguide design, therefore, requires a smaller drive power for unguiding to occur than a straight mode extinction modulator.

To achieve attenuation in excess of 30 dB, the VOA according to a preferred embodiment of the present invention uses an increase of electrode temperature of about 40 K. This is similar to temperatures required by polymer thermo-optic 1×2 switches. Conventional 1×2 switches require an operating power of about 100 mW. Since the VOA requires similar temperatures for attenuation in excess of 30 dB, electrical drive powers of 100 mW can be used.

In addition, the attenuation of the VOA according to a preferred embodiment of the present invention may have a small dependence on wavelength changes. For example, varying the wavelength between 1.53 μm to 1.57 μm can cause a 3 dB difference in insertion loss at an attenuation level of 25 dB. FIG. 9 illustrates the VOA response (attenuation) as a function of wavelength. Since longer wavelengths typically have less confinement, they experience more attenuation than shorter wavelengths.

According to alternative embodiments of the present invention, the VOA response can be made independent of wavelength. In one alternative embodiment of the present invention designed to flatten the wavelength response, a waveguide with a negative dispersion of refractive index (wherein the refractive index increases with wavelength) is fabricated.

In a second alternative embodiment of the present invention designed to flatten the wavelength response, power is applied to the waveguide via an electrode (or similar circuit), thereby changing the waveguide wavelength dispersion.

In a third alternative embodiment of the present invention designed to flatten the wavelength response, waveguide directional couplers are included to flatten the wavelength response by increasing attenuation for shorter wavelengths.

In a fourth alternative embodiment of the present invention designed to flatten the wavelength response, an interferometer (such as a Mach-Zehnder device) is further included to increase attenuation for shorter wavelengths to match the waveguide bend loss for longer wavelengths.

In a fifth alternative embodiment of the present invention designed to flatten the wavelength response, a multimode waveguide segment is further included to create single mode conditions for longer wavelengths and various multimode conditions for shorter wavelengths. By applying power to an electrode above the multimode section, single mode conditions can be created for all wavelengths or for just the longest wavelengths present. By using the wavelength dependence for coupling into the single mode and multimode regions, the waveguide bend spectral response can be complemented.

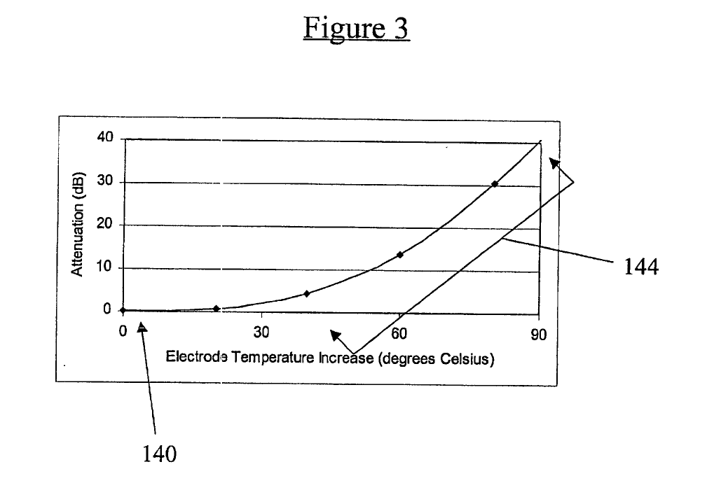

For example, as shown in FIG. 11, an interferometer 161 is placed proximate to curved region 166. As would be apparent to one of ordinary skill in the art given the present description, interferometer 161 can also be included at locations 160, 162, or 164 (i.e., before, after, or within the curved region 166 of the VOA). These design alternatives are also applicable for the other additional devices described above.

For certain applications, however, a wavelength dependence is acceptable. For example, a wavelength selective cross connect (WSXC) will require a VOA for each separate wavelength channel present. Since each VOA would control a separate wavelength, the wavelength dependence is not critical. Indeed, because each VOA can be optimized to operate at a specific wavelength, and because wavelengths longer than the optimum would experience higher loss, the VOA also reduces crosstalk between the separate wavelength channels. For example, a WSXC with 128 wavelength channels would use 128 VOAs. In this application, the cost per VOA is a more practical consideration than the VOA wavelength dependence.

Moreover, for particular VOA applications, a polarization dependence of less than 0.2 dB is required if the VOA response time is slow (˜10 ms). Higher polarization dependence is acceptable for VOAs operating at ≦1 millisecond (ms) signal by using feedback control. The attenuation response time at which the VOA operates depends on how fast heat can be transferred to the area around the waveguide core. Since the VOA requires similar temperatures to those required by a polymer 1×2 thermo-optic switch, similar speeds are expected. For example, a preferred VOA has a response time of about 1 ms to about 10 ms for attenuations greater than 20 dB.

FIGS. 4 and 5 show beam propagation results for a representative structure, where the optical signal radiation loss occurs with an electrode temperature change. The VOA waveguide in FIG. 4 has no power applied to the resistive heater, whereas the VOA waveguide in FIG. 5 has the heater turned on. The plots show the beam propagation for the two different situations. The waveguide in this example includes three segments. The first segments (60 and 80) and third segments (62 and 82) are straight waveguides having a length of about 1 mm. The center segment (64 and 84) is a curved waveguide of length about 1 mm. It can be seen from FIG. 4 that a very small amount of mode coupling loss 66 occurs while entering and leaving the curved waveguide due to the normal mode distortion. FIG. 5 shows the exponential attenuation of the optical mode as it propagates around the curved waveguide region 86. There, according to a preferred embodiment of the present invention, an electrode, such as a resistive heater can be positioned to reduce the vertical mode confinement, thereby increasing the radiation loss of the curved waveguide region.

An optimum bending radius for the curved waveguide region of the VOA can be determined by performing beam propagation simulations. In an example simulation, a wavelength of 1.5 μm, a waveguide width of about 7 μm, a core-cladding index difference of 0.5%, and a 0.5 centimeter (cm) bending path length are used. The simulations can be made using the output power as a function of bending radius for situations with and without an electrode temperature change. For example, under these conditions, at a bending radius of 7.6 mm there exists the largest extinction ratio of the device. At this value, with no signal applied to the heater, an excess loss of about 0.2 dB is obtained due to bending radiation. Assuming a coupling loss of 0.2 dB (for this waveguide size and index difference) and a 0.3 dB cm⁻¹ waveguide propagation loss, a total insertion loss of less than 1 dB can be expected under these conditions. However, the bending path length, bend radius, and waveguide width can be optimized to reduce this insertion loss for specific applications.

An alternative embodiment of the present invention is shown in FIG. 13. In this embodiment, the curved region of the waveguide 240 has a portion with a narrower width than the input 242 and output 244 waveguide segments. Input waveguide segment 242 preferably has a straight shape, although a non-straight input may be utilized, especially if it is combined on a substrate with additional waveguide devices, as would be apparent to one of skill in the art given the present description. In a preferred embodiment, two tapers 246 and 248 are included at the interfaces between the straight waveguide segments and the curved waveguide region. For example, as shown in cross-sectional views 250 and 252, the cross-section of the straight input and output waveguides can measure 7 μm high by 7 μm wide, while the cross-section of the curved waveguide region can measure 7 μm high by 3 μm wide (as shown in cross-sectional view 254). As would be apparent to one of skill in the art given the present description, other height and width values can be utilized. This design results in a VOA that requires less driving power to be applied to the electrode to achieve a given optical signal attenuation.

This improvement is illustrated in FIG. 14, which shows that at a set heater temperature, a larger attenuation is achieved for a tapered waveguide. According to this design, a wider waveguide section is advantageous for fiber coupling and the narrower waveguide section is advantageous for attenuation.

FIG. 8 illustrates another embodiment of the present invention, a VOA 104 with a feedback control circuit 101. The feedback control circuit in this example includes a feedback detector 103 and a feedback circuit 102. The feedback control circuit also includes a waveguide tap 100 that can couple a percentage of the VOA output, preferably about 1% to about 10%. The feedback circuit 102 controls the signal, e.g. current, applied to the electrode. For example, a VOA with a dynamic range in excess of 30 dB can have a curved waveguide region with an overall length of about 1 cm to about 1.5 cm.

Generally, a minimum insertion loss should be no greater than 1 dB for a VOA alone and no greater than 1.5 dB if a feedback tap coupler is included in the VOA device. The total insertion loss of the submitted design includes fiber coupling, propagation loss, minimum bend loss, and feedback tap loss. A low insertion loss is possible with use of single mode waveguides made out of fluorinated polymers, with propagation losses of about 0.2 dB cm⁻¹. This insertion loss estimate includes losses due to both material absorption and scattering. For example, the chemical formula for a preferred multifunctional fluorinated (meth)acrylate low loss optical polymer is shown in FIG. 16. Additional information about these materials is disclosed in U.S. patent application Ser. No. 09/745,076, filed on Dec. 20, 2000, the content of which is hereby incorporated by reference in its entirety. These materials have produced waveguides with propagation losses of as little as 0.19 dB/cm at 1550 nm. Tg's of these materials can be easily selected to he below the operating temperature of thermo-optic devices. Low Tg versions of these materials have been shown to have negligible birefringence by grating assisted measurements. By using such a low loss polymer, a VOA with 1 dB of insertion loss is achievable. The values in Table I show how this low minimum insertion loss can be achieved:

TABLE 1

| | | |
|---|---|---|
| Fiber coupling | 0.2 dB × 2 | 0.4 dB |
| Propagation loss | 0.2 dB cm⁻¹ × <1.5 cm | <0.3 dB |
| Minimum bend loss | | <0.1 dB |
| (no power applied to heater) | | |
| Feedback tap loss | <5% tap | <0.2 dB |
| Total | | <1.0 dB |

The overall insertion loss of the VOA can be reduced even further if it is directly integrated with other waveguide devices. The embodiment of the present invention shown in FIG. 7 is illustrative in this regard. Here, a VOA is integrated with a Y-branch switch 220 having two output ports 222 and 224. In this example, a waveguide bend attenuator is integrated with one of the output ports 222 of the Y-branch switch 220. Switch electrodes 226 are integrated with the Y-branch device. By activating the attenuator located in an “off” port, the switch extinction ratio can be increased from the typical 25 dB to about 50 dB. Because the VOA attenuation range scales with length, a VOA according to this embodiment need only to be a few millimeters in length to achieve this level of attenuation.

In still another embodiment of the present invention, as shown in FIG. 15, a VOA 310 can be fabricated at the ends of waveguide output arrays 312 such as from an optical cross connect 311 for power equalization, as would be apparent to one of ordinary skill in the art given the present description. This increases the functionality contained in a single chip, and it also eliminates the loss associated with extra fiber- waveguide couplings. This will also save in extra packaging costs.

The VOA of the embodiments described above can be incorporated with other integrated optic devices on a single substrate to improve switching performance or provide modulation. A preferred VOA design uses a standard passive polymer material that can be used to fabricate Y-branch switches, directional couplers, phasars, and other integrated waveguide devices. Furthermore, large attenuation is possible even with small path lengths.

FIG. 6 shows an example simulation result for the attenuation length dependence of a VOA according to a preferred embodiment of the present invention. No attenuation is provided by the straight input 200 and output 202 regions, while linear attenuation is provided by the curved region of the VOA, see graph portion 204. The graph shows that at a bend length of about 1 cm, an extinction ratio of 30 dB is obtained.

The VOA of the present invention has a further advantage in that it can be fabricated through a straightforward fabrication technique, thus avoiding the need for additional device layers utilized in conventional VOAs that operate based on an alteration of the horizontal mode confinement.

FIG. 12 illustrates an example fabrication technique for the present invention. Generally, a standard technique such as spin-casting can be used to create the cladding and core layers on the substrate.

In this example a silicon or silica substrate 260, having a thickness of about 1 mm, can be used. The cladding layer 262 and core layer 264 are then deposited on the substrate 260. The thickness of the cladding layer 262 and core layer 264 can be controlled during spin-coating by controlling the spin speed and time. In addition, the VOA structure can further include a buffer layer 265 deposited between the substrate and cladding layers, as would be apparent to one of skill in the art given the present description.

A conventional photolithographic or etching technique can be used to further define the waveguide. For example, ultraviolet radiation 266 and a photo-mask 270 can be used to define a core layer width, such as, in a preferred embodiment, about 7 μm. Optionally, one or more alignment marks 272 can also be utilized for alignment purposes. Lift-off patterning of an electrode layer 268 can be used to complete the VOA structure.

Another advantage of the VOA design according to the present invention as compared to conventional VOAs is lower device cost and smaller device size. For example, a WSXC requires one VOA per wavelength channel. For a 4×4 cross connect with 32 wavelengths per fiber, that amounts to 128 VOAs. By integrating a waveguide tap, this VOA design can eliminate the need for an external tap coupler. In addition, the cost of such a device can be reduced, due to factors such as: the low cost of polymer waveguide processing, the ability to integrate a VOA according to the embodiments described above with other waveguide devices, and the ability to create arrays of devices on a single substrate. If 128 VOAs are required for the multi-channel device, this results in a substantial cost savings.

Furthermore, with respect to size considerations, only four commercially available VOAs with feedback control fit on a 20 in² card because of the package size and the space required for fiber connections. The limiting factor for this conventional VOA design is the space required for the fiber blocks and feedback detectors. Even a conservative estimate assuming a 5 cm×1 cm space for a VOA according to the present invention can allow more than 20 devices per card. Integrating the VOAs directly with the waveguide cross connect device results in an even further reduction in space, packaging cost, and insertion loss.

Other advantages of the VOA according to the present invention, as compared to a conventional waveguide with a Mach-Zehnder or Y-branch switch, include size, insertion loss, fabrication tolerances, and performance. Mach-Zehnder and Y-branch switches have a minimum length required by the incorporated Y-branches. Conventional devices are about 3 cm long. This increased length increases the insertion loss of the device. Additionally, these devices are very sensitive to fabrication errors of the Y-branches.

The waveguide bend VOA according to a preferred embodiment of the present invention is tolerant of fabrication errors. For example, an electrode need only to be aligned within ±5 μm. In contrast, Mach-Zehnder and Y-branch devices can only tolerate fabrication errors to less than ±1 μm. Moreover, since the attenuation of the waveguide bend VOA scales with length, the size can be adjusted to fit the performance requirements. Mach-Zehnder and Y-branch devices are based on modal interference or adiabatic principles. For low loss conditions, the required length of these devices remains roughly the same whether a 10 dB or 20 dB range is needed by the application. Finally, the attainable fabrication accuracy limits the according to a preferred embodiment of the present invention can attenuate a signal over 30 dB. Compared to Mach-Zehnder or 1×2 switches, the waveguide bend VOA has lower insertion loss, much higher fabrication tolerances, and larger performance levels.

Yet another advantage of the present invention is that the waveguide is made with similar core and cladding material, thereby simplifying and economizing the fabrication process and greatly reducing sensitivity to environmental conditions such as ambient temperature and relative humidity.

While the above provides a full and complete disclosure of the preferred embodiments of the present invention, various modifications, alternate constructions, and equivalents may be employed without departing from the scope of the invention. Therefore, the above description and illustration should not be construed as limiting the scope of the invention, which is defined by the appended claims.

We claim:

1. A variable optic attenuation device, comprising:
a waveguide that includes:
a cladding layer having a first index of refraction,
a core layer having a second index of refraction, wherein said cladding layer and said core layer are comprised of the same class of material, and
a curved region having a first bend radius; and
an electrode disposed on said curved region such that, when a signal is received by said electrode, a vertical optical confinement of an optical signal in said curved region is altered.

2. The variable optic attenuation device according to claim 1, wherein said core layer is composed of fluorinated acrylate having a first index of refraction from about 1.32 to about 1.5; and
said cladding layer is composed of fluorinated acrylate, having a second index of refraction less than said first index of refraction, said second index of refraction from about 1.31 to about 1.5.

3. The variable optic attenuation device according to claim 1, wherein said core layer and said cladding layers are composed of glass materials.

4. The variable optic attenuation device according to claim 1, further comprising:
an optical device coupled to said waveguide and located before said curved region, said optical device selected from the group consisting of directional couplers, interferometers, multi-mode waveguide segments, and Mach-Zehnder modulators.

5. The variable optic attenuation device according to claim 1, further comprising:
an optical device coupled to said waveguide and located after said curved region, said optical device selected from the group consisting of directional couplers, interferometers, multi-mode waveguide segments, and Mach-Zehnder modulators.

6. The variable optic attenuation device according to claim 1, further comprising:
an optical device coupled to said waveguide and located proximate to said curved region, said optical device selected from the group consisting of directional couplers, interferometers, multi-mode waveguide segments, and Mach-Zehnder modulators.

7. The variable optic attenuation device according to claim 1, further comprising:
a feedback detector and optical power tap located after said curved region to detect said optical signal; and
a feedback circuit, connected to said feedback detector and said electrode, for automatically controlling a power of said optical signal exiting said variable optical attenuation device.

8. The variable optic attenuation device according to claim 1, wherein a length of said curved region is about 1 centimeter and a power of said optical signal exiting said curved region is reduced by at least 30 dB.

9. The variable optic attenuation device according to claim 1, further comprising:
a first tapered portion extending from an input portion of the waveguide to an input portion of said curved region, wherein a width of the waveguide is gradually reduced over said first tapered portion; and
a second tapered portion extending from an output portion of said curved region to an output portion of the waveguide, wherein a width of the waveguide is gradually increased over said second tapered portion.

10. The variable optic attenuation device according to claim 9, wherein one of said input and output portions of the waveguide has a width of about 7 micrometers and wherein a width of said curved region is about 3 micrometers.

11. A method of variable optical attenuation, comprising:
providing a waveguide that includes a cladding layer having a first index of refraction, a core layer having a second index of refraction and comprised of the same class of material as said cladding layer, a curved region having a first bending radius, and an electrode disposed on said curved region; and
altering a vertical confinement of an optical mode of an optical signal in said curved region.

12. The method according to claim 11, further comprising:
coupling an optical device proximate to said curved region, said optical device selected from the group consisting of directional couplers, interferometers, multi-mode waveguide segments, and Mach-Zehnder modulators.

13. The method according to claim 13, further comprising:
automatically controlling an output power of said optical signal exiting said waveguide.

14. The method according to claim 13, comprising:
providing a feedback detector and optical power tap located after said curved region to detect said optical signal; and
providing a feedback circuit connected to said feedback detector and said electrode to control a power of said signal exiting said waveguide.

15. The method according to claim 11, comprising:
providing a first tapered portion extending from an input portion of the waveguide to an input portion of said curved region, wherein a width of the waveguide is gradually reduced over said first tapered portion; and
providing a second tapered portion extending from an output portion of said curved region to an output portion of the waveguide, wherein a width of the waveguide is gradually increased over said second tapered portion.
